(19) United States
(12) Patent Application Publication
(10) Pub. No.: US 2006/0017853 A1
(43) Pub. Date: Jan. 26, 2006

(54) Method of composing video signal, apparatus to compose video signal, display system, display apparatus and control method of display apparatus

(76) Inventors: Jae-hyung Chang, Seongnam-si (KR); Young-chan Kim, Euiwang-si (KR)

Correspondence Address: STANZIONE & KIM, LLP, 919 18TH STREET, N.W., SUITE 440, WASHINGTON, DC, 20006, US

(21) Appl. No.: 11/144,738

(22) Filed: Jun. 6, 2005

(30) Foreign Application Priority Data
Jul. 26, 2004 (KR) 2004-58247

(51) Int. Cl. H04N 5/45

(52) U.S. Cl. 348/584; 348/565

(57) ABSTRACT

A method of composing a plurality of individual video signals, the method comprises creating a composed horizontal synchronous signal and a composed vertical synchronous signal to synchronize the plurality of individual video signals, and creating a composed video signal by synchronizing line data of the plurality of individual video signals with the composed horizontal synchronous signal and the composed vertical synchronous signal by a frame unit in a predetermined order. Thus, the method of composing a video signal, an apparatus to comprise a video signal, a display system, a display apparatus, and a control method of the display apparatus, composes a plurality of individual video signals into a composed video signal, to thereby transmit the composed video signal through a single cable.

### CROSS-REFERENCE TO RELATED APPLICATIONS

This application claims the benefit of Korean Patent Application No. 2004-58247, filed on Jul. 26, 2004, in the Korean Intellectual Property Office, the disclosure of which is incorporated herein in its entirety and by reference.

### BACKGROUND OF THE INVENTION

1. Field of the Invention

The present general inventive concept relates to a method of composing a video signal, an apparatus to compose a video signal, a display system, a display apparatus, and a control method of the display apparatus, and more particularly, to a method of composing a video signal, an apparatus to compose a video signal, a display system, a display apparatus, and a control method of the display apparatus, in which a plurality of individual video signals is transmitted through a single cable.

2. Description of the Related Art

Generally, a display apparatus such as a television, a monitor, etc., receives a video signal of various formats and displays it as a picture. For example, there are various video signals such as a general radio frequency (RF) signal transmitted from a broadcasting station, a composite signal similar to the RF signal, an S-video signal transmitted as divided into a color signal and a contrast signal, a component signal including a brightness (Y) signal, contrast signal and a color signal (Cb, Cr); or etc., which are displayed as a picture.

Accordingly, to receive the video signal of various formats transmitted from a video signal source, a display apparatus has been recently provided with various input terminals corresponding to various formats of the video signal.

As an example, FIG. 1 is a control block diagram illustrating a conventional display apparatus having a PIP (picture in picture) function. As shown therein, a display apparatus 150 comprises a display part 156 displaying a picture thereon, a first input terminal 154a and a second input terminal 154b to receive analog RGB signals, respectively, a first A/D converter 157a and a second A/D converter 157b to respectively convert the analog RGB signals received through the first and second input terminals 154a and 154b into digital RGB signals, a scaler 158 to scale the digital RGB signals received from the first and second A/D converters 157a and 157b corresponding to a format thereof, and a controller 155 to control them.

Further, the display apparatus 150 comprises a PIP processor 159 to process the digital RGB signal transmitted from either the first A/D converter 157a or the second A/D converter 157b on the basis of a PIP function. Generally, the PIP processor 159 is provided as one function of the scaler 158.

The controller 155 controls the PIP processor 159 and the scaler 158, thereby allowing one of the digital RGB video signals transmitted from the first and second A/D converters 157a and 157b to be displayed as a main picture on a whole region of the display part 156, and the other one to be displayed as a subsidiary picture on a partial region of the display part 156 on the basis of the PIP function.

However, in order to display two or more pictures on one display part 156, the conventional display apparatus 150 must receive the video signals through the first and second input terminals 154a and 154b. Further, the conventional display apparatus 150 must be connected to two or more video signal sources through cables connected to the first and second input terminals 154a and 154b thereof.

Accordingly, if a single cable is used to transmit two or more video signals from the video signal sources to a display apparatus, a display system is more convenient for a user.

### SUMMARY OF THE INVENTION

Accordingly, the present general inventive concept provides a method of composing a video signal, an apparatus to compose a video signal, a display system, a display apparatus, and a control method of the display apparatus, in which a plurality of individual video signals is composed into a composed video signal, thereby transmitting the plurality of individual video signals through a single cable.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of composing a plurality of individual video signals, the method comprising creating a composed horizontal synchronous signal and a composed vertical synchronous signal to synchronize the plurality of individual video signals, and creating a composed video signal by synchronizing line data of the plurality of individual video signals with the composed horizontal synchronous signal and the composed vertical synchronous signal by a frame unit in a predetermined order.

The creating of the composed vertical synchronous signal may comprise detecting the frequency of an individual vertical synchronous signal of each individual video signal, calculating the frequency of the composed vertical synchronous signal according to the detected frequency of the individual vertical synchronous signal of each individual video signal, and creating the composed vertical synchronous signal having the calculated frequency.

The creating of the composed video signal may comprise alternately synchronizing the line data of the plurality of individual video signals with the composed horizontal synchronous signal, and composing each frame of the plurality of individual video signals and synchronizing the composed video signal with the composed vertical synchronous signal.

The foregoing and/or other aspects and advantages of the present general inventive concept may also be achieved by providing a display system comprising a video signal output apparatus to output a composed video signal, a composed horizontal synchronous signal and a composed vertical synchronous signal, a signal receiver to receive the composed video signal, the composed horizontal synchronous signal and the composed vertical synchronous signal from the video signal output apparatus, a signal divider to divide the composed video signal received through the signal receiver into a plurality of individual video signals according to the composed horizontal synchronous signal and the composed vertical synchronous signal, a synchronous signal generator to generate an individual horizontal synchronous signal and an individual vertical synchronous signal to synchronize each individual video signal according to the composed horizontal synchronous signal and the composed vertical synchronous signal received through the signal receiver, a signal processor to process the plurality of individual video signals divided by the signal divider to have a format to be displayable on a display, and a controller to control the signal processor to process at least one of the plurality of individual video signals output from the signal divider to be displayed on the display according to the individual horizontal synchronous signal and the individual vertical synchronous signal.

The signal processor may comprise a PIP processor to perform a PIP function, and the controller can control the PIP processor and the signal processor to display one of the plurality of individual video signals output from the signal divider as a main picture on the display, and another one of the plurality of individual video signals as a subsidiary picture on a portion of the display by the PIP processor.

The video signal output apparatus and the signal receiver can be connected by a single cable.

The foregoing and/or other aspects and advantages of the present general inventive concept may also be achieved by providing an apparatus to compose a video signal, the apparatus comprising a signal composing part to compose a plurality of individual video signals into a composed video signal, a composed horizontal synchronous signal and a composed vertical synchronous signal, and a signal output part to output the composed video signal, the composed horizontal synchronous signal and the composed vertical synchronous signal.

The foregoing and/or other aspects and advantages of the present general inventive concept may also be achieved by providing a display apparatus having a display on which a picture is displayed, the display apparatus comprising a signal receiver to receive a composed video signal, a composed horizontal synchronous signal and a composed vertical synchronous signal, a signal divider to divide the composed video signal received through the signal receiver into a plurality of individual video signals according to the composed horizontal synchronous signal and the composed vertical synchronous signal, a synchronous signal generator to generate an individual horizontal synchronous signal and an individual vertical synchronous signal to synchronize each individual video signal according to the composed horizontal synchronous signal and the composed vertical synchronous signal received through the signal receiver, a signal processor to process the plurality of individual video signals divided by the signal divider to have a format to be displayable on a display, and a controller to control the signal processor to process at least one of the plurality of individual video signals output from the signal divider to be displayed on the display according to the individual horizontal synchronous signal and the individual vertical synchronous signal.

The signal processor may comprise a PIP processor to perform a PIP function, and the controller can control the PIP processor and the signal processor to display one of the plurality of individual video signals output from the signal divider as a main picture on the display, and another one of the plurality of individual video signals as a subsidiary picture on a portion of the display by the PIP processor.

The foregoing and/or other aspects and advantages of the present general inventive concept may also be achieved by providing a method of displaying a picture by a display apparatus having a display on which a picture is displayed, the method comprising receiving a composed video signal, a composed horizontal synchronous signal and a composed vertical synchronous signal, dividing the composed video signal into a plurality of individual video signals according to the composed horizontal synchronous signal and the composed vertical synchronous signal, generating an individual horizontal synchronous signal and an individual vertical synchronous signal to synchronize each individual video signal according to the composed horizontal synchronous signal and the composed vertical synchronous signal, and displaying at least one of the plurality of individual video signals on the display according to the individual horizontal synchronous signal and the individual vertical synchronous signal.

The displaying of the at least one of the plurality of individual video signals on the display may comprise displaying one of the plurality of individual video signals as a main picture on the display, and displaying another one of the plurality of individual video signals as a subsidiary picture on a portion of the display.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a control block diagram illustrating a conventional display apparatus having a PIP (picture in picture) function;

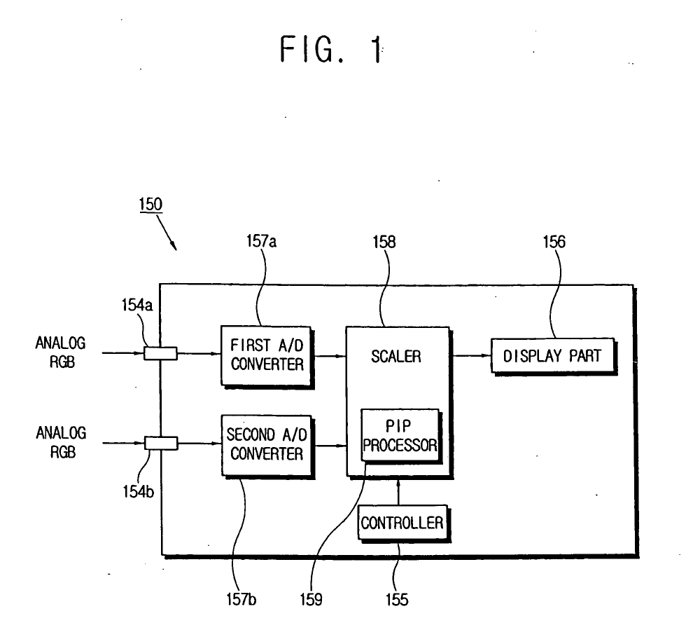

FIG. 2 is a control block diagram illustrating a display system according to an embodiment of the present general inventive concept;

FIG. 3 is a view illustrating timing among signals output from a first video signal output apparatus of FIG. 2;

FIG. 4 is a view illustrating timing among signals output from a second video signal output apparatus of FIG. 2;

FIG. 5 is a control flowchart illustrating a method of composing a video signal according to an embodiment of the present general inventive concept;

FIG. 6 is a view illustrating timing among composed signals created by the method of FIG. 5;

FIG. 7 is a control block diagram illustrating a display apparatus of FIG. 3; and

FIG. 8 is a view illustrating a picture displayed by the display apparatus of FIG. 7.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

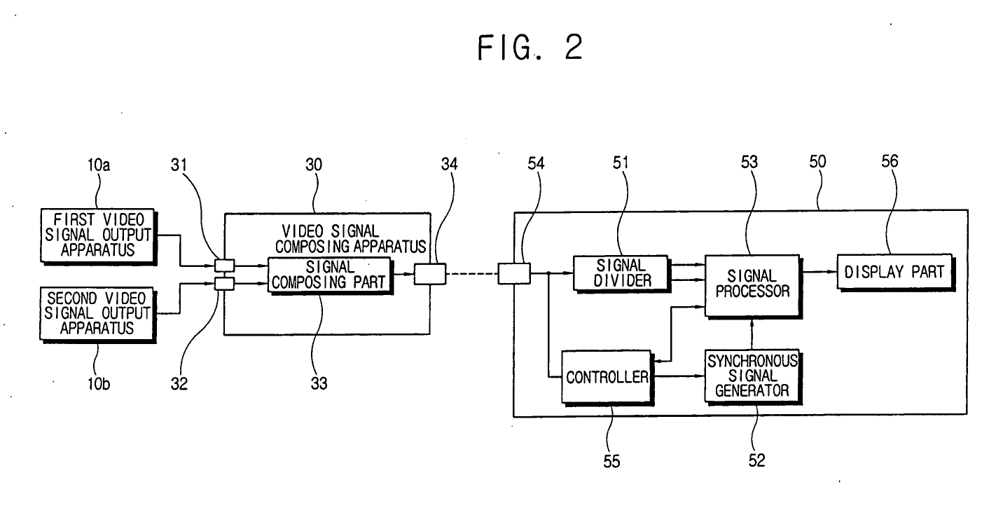

FIG. 2 is a control block diagram illustrating a display system according to an embodiment of the present general inventive concept. As shown therein, the display system may comprise a video signal composing apparatus 30 to create a composed video signal, and a display apparatus 50 to display a picture based on the composed video signal received from the video signal composing apparatus 30.

The video signal composing apparatus 30 according may comprise a plurality of signal input parts to receive a plurality of individual video signals, a signal composing part 33 to compose the plurality of individual video signals respectively transmitted through the plurality of signal input parts into the composed video signal, and a signal output part 34 to transmit the composed video signal from the signal composing part 33 to the display apparatus 50.

The plurality of signal input parts can comprise a first signal input part 31 connected to a first video signal output apparatus 10a that outputs a first individual video signal, and a second signal input part 32 connected to a second video signal output apparatus 10b that outputs a second individual video signal. Here, the first and second video signal output apparatuses 10a and 10b may include various video signal sources such as a computer, a DVD player, a set top box, or the like.

The first and second individual video signals may include an analog video signal of various formats. For example, each of the first and second individual video signals can have one format among analog RGB video signal, analog S-video signal, a component video signal, and a composite video signal.

Further, the first video signal output apparatus 10a can output a first individual horizontal synchronous signal and a first individual vertical synchronous signal corresponding to the first individual video signal to the display apparatus 50. Also, the second video signal output apparatus 10b can output a second individual horizontal synchronous signal and a second individual vertical synchronous signal corresponding to the second individual video signal to the display apparatus 50. Here, the first individual horizontal synchronous signal and the first individual vertical synchronous signal are input to the video signal composing apparatus 30 through the first signal input part 31. Also, the second individual horizontal synchronous signal and the second individual vertical synchronous signal are input to the video signal composing part 30 through the second signal input part 32.

The signal composing part 33 composes the first and second individual video signals respectively transmitted through the first and second signal input parts 31 and 32 and creates the composed video signal.

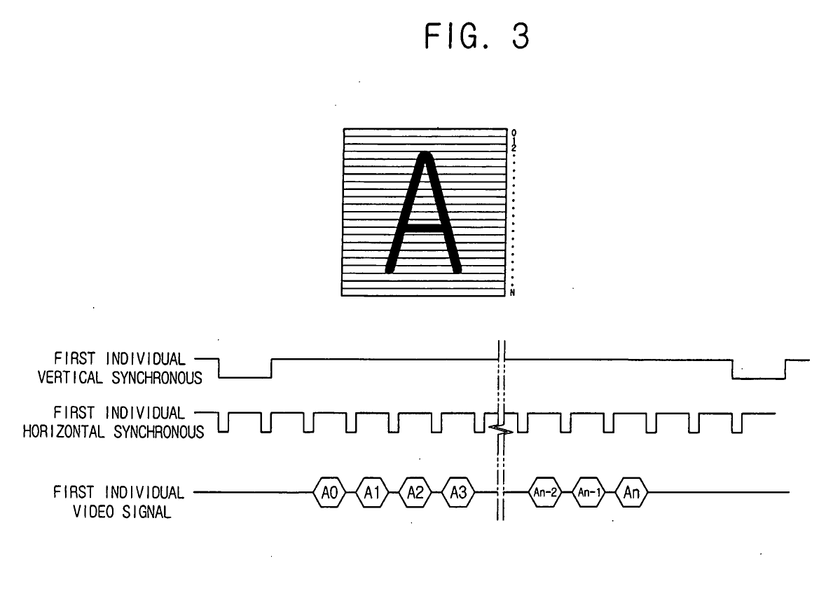

Hereinbelow, a method of composing the first individual video signal and the second individual video signal through the signal composing part 33 will be described with reference to FIGS. 3 through 6.

FIG. 3 is a view illustrating timing among the first individual vertical synchronous signal, the first individual horizontal synchronous signal and the first individual video signal.

Here, one frame of the first individual video signal displays the picture of “A” as shown in FIG. 3 by way of example. At this time, it is supposed that one frame of the first individual video signal comprises N+1 lines (A0, A1, A2 . . . An) of data. Further, each line data is synchronized with the first individual horizontal synchronous signal, and the frames of the first individual video signal are divided by the first individual vertical synchronous signal.

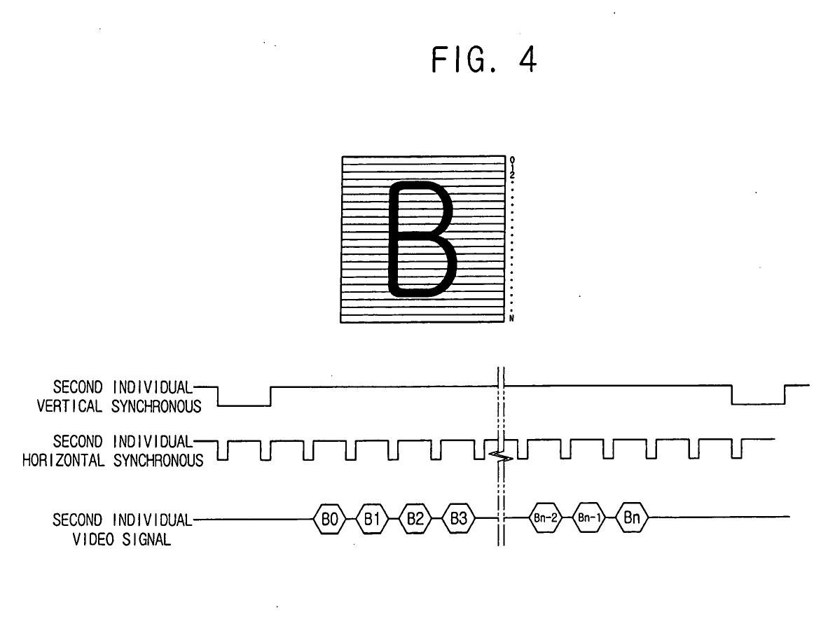

FIG. 4 is a view illustrating timing among the second individual vertical synchronous signal, the second individual horizontal synchronous signal and the second individual video signal.

Here, one frame of the second individual video signal displays the picture of “B” as shown in FIG. 4 by way of example. At this time, it is supposed that one frame of the second individual video signal comprises N+1 lines (B0, B1, B2 . . . Bn) of data. Further, each line data is synchronized with the second individual horizontal synchronous signal, and the frames of the second individual video signal are divided by the second individual vertical synchronous signal.

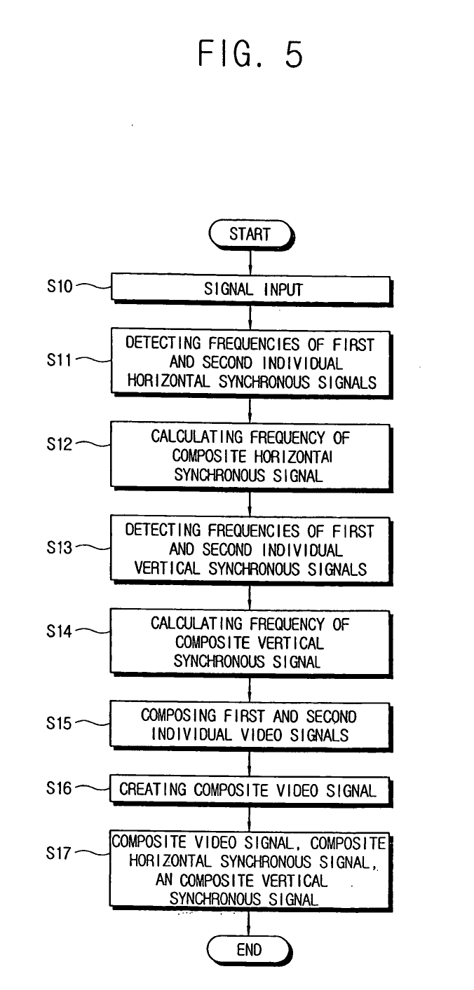

Referring to FIG. 5, the method of composing the video signals through the signal composing part 33 according to an embodiment of the present general inventive concept is as follows.

First, at operation S10, the first individual video signal, the first individual vertical synchronous signal, and the first individual horizontal synchronous signal are received through the first signal input part 31. At the same time, the second individual video signal, the second individual vertical synchronous signal, and the second individual horizontal synchronous signal are received through the second signal input part 32. Then, at operation S11, the signal composing part 33 detects the frequencies of the first and second individual horizontal synchronous signals.

At operation S12, the frequency of a composed horizontal synchronous signal is calculated according to the detected frequencies of the first and second individual horizontal synchronous signals. For example, the frequencies of the first and second individual horizontal synchronous signals can be equal to each other, and when the frequencies of the first and second horizontal synchronous signals are equal, the composed horizontal synchronous signal has the same frequency as the first or second individual horizontal synchronous signals.

At operation S13, the signal composing part 33 detects the frequencies of the first and second individual vertical synchronous signals.

At operation S14, the frequency of a composed vertical synchronous signal is calculated according to the detected frequencies of the first and second individual vertical synchronous signals. For example, when the first and second individual vertical synchronous signals have an equal frequency of 60 Hz, the composed vertical synchronous signal can have a frequency of 30 Hz as a half of the frequencies of the first and second individual vertical synchronous signals. Hence, each frame of the first individual video signal and the second individual video signal can be composed into a composed frame of the composed video signal, wherein the composed frame is synchronized with the composed vertical synchronous signal having the frequency of 30 Hz.

At operation S15, the signal composing part 33 composes the first and second individual video signals according to the composed horizontal synchronous signal and the composed vertical synchronous signal. Here, the signal composing part 33 can compose the line data of the first and second individual video signals by a frame unit in a predetermined order.

At operation S16, the signal composed at the operation S15 is synchronized with the composed horizontal synchronous signal and the composed vertical synchronous signal, thereby creating a composed video signal.

At operation S17, the signal composing part 33 transmits the composed video signal, the composed horizontal synchronous signal and the composed vertical synchronous signal to the display apparatus 50 through the signal output part 34.

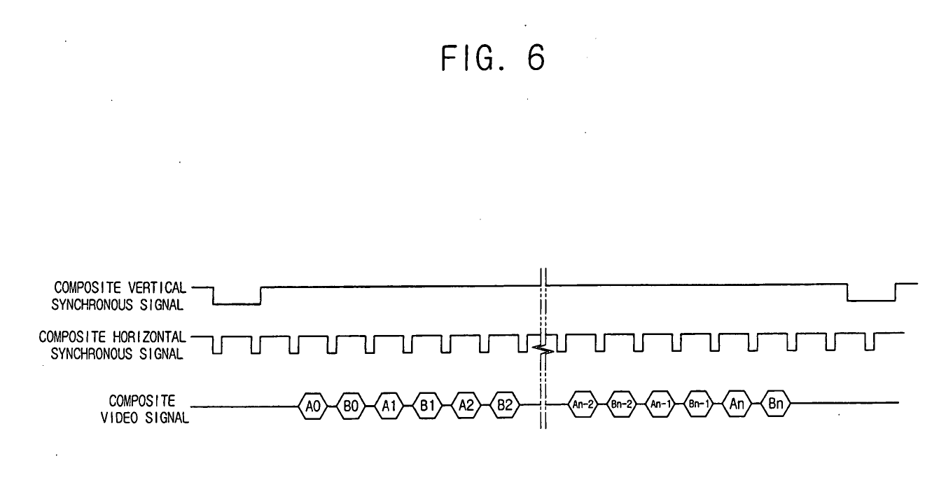

FIG. 6 is a view illustrating timing among the composed video signal, the composed horizontal synchronous signal and the composed vertical synchronous signal, created by the method of FIG. 5. The composed video signal comprises the line data (A0, A1, A2 . . . An) of the first individual video signal arranged in each even numbered line thereof in sequence, and the line data (B0, B1, B2 . . . Bn) of the second individual video signal arranged in each odd numbered line thereof in sequence. That is, the line data of the first and second video signals can be arranged as shown in FIG. 6, for example, A0, B0, A1, B1, A2, B2 . . . An, Bn (starting with line 0). It is also possible that all of the line data (B0, B1, B2 . . . Bn) of the second video signal can be arranged behind all of the line data (A0, A1, A2 . . . An) of the first video signal between the composed vertical synchronous signals. In this case it is possible the frequency of the composed vertical synchronous signal is the same as the frequency of the first individual vertical frequency or the second individual vertical frequency.

Here, the format of the composed video signal corresponds to each format of the first individual video signal and the second individual video signal. For example, in the case where the first and second individual video signals have the analog RGB signal formats, the composed video signal also has the analog RGB signal format. Thus, the configuration of the signal output part 34 to output the composed video signal corresponds to the signal input parts 31 and 32.

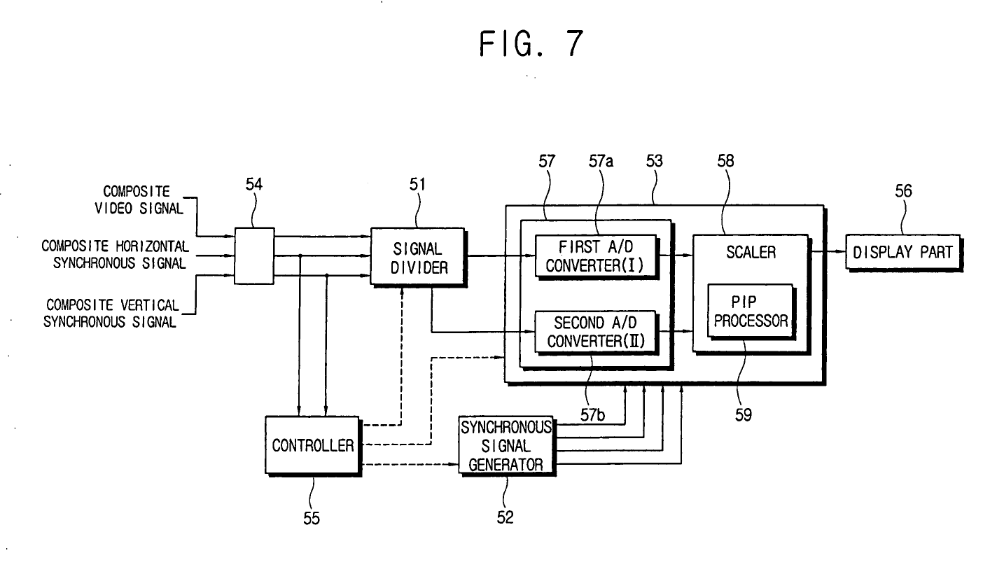

Referring to FIG. 2, the display apparatus 50 may comprise a signal receiver 54, a signal divider 51, a synchronous signal generator 52, a signal processor 53, a display part 56, and a controller 55 to control the signal divider 51, the synchronous signal generator 52, the signal processor 53, and the display part 56. Hereinbelow, the display apparatus 50 of FIG. 2 will be further described with reference to FIG. 7.

The signal receiver 54 cam receive the composed video signal, the composed horizontal synchronous signal and the composed vertical synchronous signal from the video signal composing apparatus 30. Here, the signal output part 34 of the video signal composing apparatus 30 can be connected to the signal receiver 54 of the display apparatus 50 via a single cable. That is, the video signal composing apparatus 30 composes the plurality of individual video signals into one composed video signal, and the composed video signal is transmitted to the display apparatus 50 via the single cable.

Here, the configuration of the signal output part 34 of the video signal composing apparatus 30 and the signal receiver 54 of the display apparatus 50 are determined corresponding to the formats of the composed video signal. For example, in the case where the composed video signal has the analog RGB signal format, both the signal output part 34 of the video signal composing apparatus 30 and the signal receiver 54 of the display apparatus 50 can be realized as a D-sub connector.

The signal divider 51 divides the composed video signal received through the signal receiver 54 into the first individual video signal and the second individual video signal according to the composed horizontal synchronous signal and the composed vertical synchronous signal.

For example, referring to the composed video signal shown in FIG. 6, the signal divider 51 can count the composed horizontal synchronous signal, and can divide the composed horizontal synchronous signal into the first individual video signal and the second individual video signal, wherein the first individual video signal corresponds to the line data of each even numbered line and second individual video signal corresponds to the line data of each odd numbered line.

The synchronous signal generator 52 generates the first individual horizontal synchronous signal and the first individual vertical synchronous signal to synchronize the first individual video signal, and generates the second individual horizontal synchronous signal and the second individual vertical synchronous signal to synchronize the second individual video signal.

Here, the controller 55 can determine the frequencies of the first individual horizontal synchronous signal, the first individual vertical synchronous signal, the second individual horizontal synchronous signal and the second individual vertical synchronous signal according to the frequencies of the composed horizontal synchronous signal and the composed vertical synchronous signal received by the signal receiver 54.

For example, when the video signal composing apparatus 30 outputs the composed vertical synchronous signal having a frequency of 30 Hz based on the first and second individual vertical synchronous signals each having a frequency of 60 Hz, the controller 55 can control the synchronous signal generator 52 to output the first individual vertical synchronous signal having a frequency of 60 Hz and the second individual vertical synchronous signal having a frequency of 60 Hz.

Further, when the video signal composing apparatus 30 outputs the composed horizontal synchronous signal based on the first and second individual horizontal synchronous signals each having the same frequency, the controller 55 can control the synchronous signal generator 52 to output the first individual horizontal synchronous signal and the second individual horizontal synchronous signal having the same frequency with the composed horizontal synchronous signal.

The signal processor 53 can processes the first individual video signal and/or the second individual video signal divided by the signal divider 51 according to the first individual horizontal synchronous signal, the first individual vertical synchronous signal, the second individual horizontal synchronous signal, the second individual vertical synchronous signal, to thereby allow the first individual video signal and/or the second individual video signal to have a format to be displayable on the display part 56.

Here, the controller 55 can control the signal processor 53 to display at least one of the first individual video signal and the second individual video signal output from the signal divider 51 on the display part 56.

The signal processor 53 may comprise a scaler 58, and a signal converter 57 to convert the first and second individual video signals output from the signal divider 51 to have a digital format for the scaler 58.

Alternatively, the signal converter 57 may vary according to the formats of the first and second individual video signal. For example, when the first and second individual video signals have the analog RGB signal format, the signal converter 57 can comprise a first A/D converter 57a, and a second A/D converter 57b, as shown in FIG. 7, to convert the first and second individual video signals into digital RGB signals, respectively.

Meanwhile, the signal processor 53 may comprise a PIP processor 59 to perform a PIP function. As shown in FIG. 7, the PIP processor 59 can be fabricated with the scaler 58 as a single chip. Alternately, the PIP processor may be fabricated separately from the scaler.

Here, the controller 55 can control the signal processor 53 comprising the PIP processor 59 to display one of the first and second individual video signals having the digital RGB signal format and output from the first and second A/D converters 57a and 57b, respectively, as a main picture on a whole region of the display part 56, and display the other one as a subsidiary picture on a partial region of the display part 56 according to the PIP function.

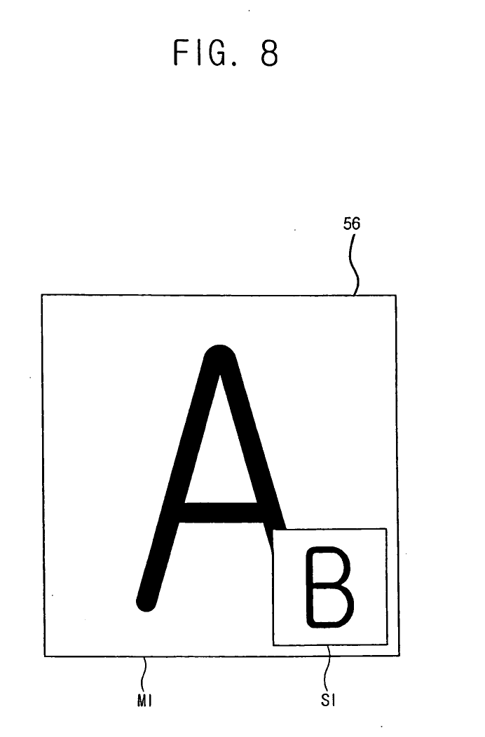

As an example, FIG. 8 illustrates that the first individual video signal is displayed as the main picture MI on the whole region of the display part 56 and the second individual video signal is displayed as the subsidiary picture SI on the partial region of the display part 56.

In the foregoing embodiment, the first video signal output apparatus 10a, the second video signal output apparatus 10b, and the video signal composing apparatus 30 are separated from each other. However, the first video signal output apparatus 10a, the second video signal output apparatus 10b, and the video signal composing apparatus 30 may be formed as a single video signal source. For example, in the case where the video signal source includes a DVD player, the DVD player may comprise two or more playback parts for playing two or more DVDs, and a single output terminal to output one composed video signal based on video signals transmitted from two or more playback parts.

Thus, the composed horizontal synchronous signal and the composed vertical synchronous signal are created, and the line data of the plurality of individual video signals is synchronized with the composed horizontal synchronous signal and the composed vertical synchronous signal by the frame unit in a predetermined order, so that the composed video signal is created, thereby transmitting the composite video signal to the display apparatus 50 through the single cable from the video signal source.

As described above, the present general inventive concept provides a method of composing a video signal, an apparatus to compose a video signal, a display system, a display apparatus, and a control method of the display apparatus, in which a plurality of individual video signals is composed into a composed video signal, to thereby transmit the composed video signal through a single cable.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of composing a plurality of individual video signals, the method comprising:
creating a composed horizontal synchronous signal and a composed vertical synchronous signal to synchronize the plurality of individual video signals; and
creating a composed video signal by synchronizing line data of the plurality of individual video signals with the composed horizontal synchronous signal and the composed vertical synchronous signal by a frame unit in a predetermined order.

2. The method according to claim 1, wherein the creating of the composed vertical synchronous signal comprises
detecting a frequency of an individual vertical synchronous signal of each of the plurality of individual video signals;
calculating a frequency of the composed vertical synchronous signal according to the detected frequency of the individual vertical synchronous signal of each of the plurality of individual video signals; and
creating the composed vertical synchronous signal having the calculated frequency.

3. The method according to claim 1, wherein the creating of the composed video signal comprises:
alternately synchronizing the line data of the plurality of individual video signals with the composed horizontal synchronous signal; and
composing each frame of the plurality of individual video signals and synchronizing the composed video signal with the composed vertical synchronous signal.

4. A display system comprising:
a video signal output apparatus to compose a plurality of individual video signals into a composed video signal, a composed horizontal synchronous signal and a composed vertical synchronous signal, and to output the composed video signal, the composed horizontal synchronous signal and the composed vertical synchronous signal;
a signal receiver to receive the composed video signal, the composed horizontal synchronous signal and the composed vertical synchronous signal from the video signal output apparatus;
a signal divider to divide the composed video signal received through the signal receiver into the plurality of individual video signals according to the composed horizontal synchronous signal and the composed vertical synchronous signal;
a synchronous signal generator to generate an individual horizontal synchronous signal and an individual vertical synchronous signal to synchronize each of the plurality of individual video signals according to the composed horizontal synchronous signal and the composed vertical synchronous signal received through the signal receiver;
a signal processor to process the plurality of individual video signals divided by the signal divider to have a format to be displayable on a display; and
a controller to control the signal processor to process at least one of the plurality of individual video signals output from the signal divider to be displayed on the display according to the individual horizontal synchronous signal and the individual vertical synchronous signal.

5. The display system according to claim 4, wherein the signal processor comprises a PIP processor to perform a PIP function, and
the controller controls the PIP processor and the signal processor to display one of the plurality of individual video signals output from the signal divider as a main picture on the display, and another one of the plurality of individual video signals as a subsidiary picture on a portion of the display.

6. The display system according to claim 5, wherein the signal processor further comprises:
a scaler having the PIP processor fabricated thereon; and
a signal converter to convert the plurality of individual video signals output from the signal divider to a format corresponding to the scaler.

7. The display system according to claim 4, wherein the video signal output apparatus and the signal receiver are connected by a single cable.

8. The display system according to claim 4, wherein the video signal output apparatus comprises:
a signal composing part to compose the plurality of individual video signals into the composed video signal, the composed horizontal synchronous signal, and the composed vertical synchronous signal; and
a signal output part to output the composed video signal, the composed horizontal synchronous signal, and the composed vertical synchronous signal.

9. The display system according to claim 4, wherein the video signal output apparatus composes the plurality of individual video signals into the composed video signal, the composed horizontal synchronous signal, and the composed vertical synchronous signal by:
creating the composed horizontal synchronous signal and the composed vertical synchronous signal to synchronize the plurality of individual video signals; and
creating the composed video signal by synchronizing line data of the plurality of individual video signals with the composed horizontal synchronous signal and the composed vertical synchronous signal by a frame unit in a predetermined order.

10. The display system according to claim 9, wherein the video signal output apparatus creates the composed vertical synchronous signal by:
detecting a frequency of an individual vertical synchronous signal of each of the plurality of individual video signals;
calculating a frequency of the composed vertical synchronous signal according to the detected frequency of the individual vertical synchronous signal of each of the plurality of individual video signals; and
creating the composed vertical synchronous signal having the calculated frequency.

11. The display system according to claim 9, wherein the video signal output apparatus creates the composed video signal by:
alternately synchronizing the line data of the plurality of individual video signals with the composed horizontal synchronous signal; and
composing each frame of the plurality of individual video signals and synchronizing the composed video signal with the composed vertical synchronous signal.

12. The display system according to claim 4, wherein the plurality of individual video signals comprises first and second individual video signals, and the composed video signal comprises first and second line data of the first and second individual video signals.

13. The display system according to claim 12, wherein the line data of the first and second individual video signals are arranged alternatively in the composed video signal.

14. An apparatus to compose a video signal, the apparatus comprising:
a signal composing part to compose a plurality of individual video signals into a composed video signal, a composed horizontal synchronous signal and a composed vertical synchronous signal; and
a signal output part to output the composed video signal, the composed horizontal synchronous signal and the composed vertical synchronous signal.

15. The apparatus according to claim 14, wherein the signal composing part composes the plurality of individual video signals into the composed video signal, the composed horizontal synchronous signal and the composed vertical synchronous signal by:
creating a composed horizontal synchronous signal and a composed vertical synchronous signal to synchronize the plurality of individual video signals; and
creating a composed video signal by synchronizing line data of the plurality of individual video signals with the composed horizontal synchronous signal and the composed vertical synchronous signal by a frame unit in a predetermined order.

16. The apparatus according to claim 15, wherein the signal composing part creates the composed vertical synchronous signal by:
detecting a frequency of an individual vertical synchronous signal of each of the plurality of individual video signals;
calculating a frequency of the composed vertical synchronous signal according to the detected frequency of the individual vertical synchronous signal of each of the plurality of individual video signals; and
creating the composed vertical synchronous signal having the calculated frequency.

17. The apparatus according to claim 15, wherein the signal composing part creates the composed video signal by:
alternately synchronizing the line data of the plurality of individual video signals with the composed horizontal synchronous signal; and
composing each frame of the plurality of individual video signals and synchronizing the composed video signal with the composed vertical synchronous signal.

18. A display apparatus having a display to display a picture thereon, the display apparatus comprising:
a signal receiver to receive a composed video signal, a composed horizontal synchronous signal and a composed vertical synchronous signal
a signal divider to divide the composed video signal received through the signal receiver into a plurality of individual video signals according to the composed horizontal synchronous signal and the composed vertical synchronous signal;
a synchronous signal generator to generate an individual horizontal synchronous signal and an individual vertical synchronous signal to synchronize each of the plurality of individual video signals according to the composed horizontal synchronous signal and the composed vertical synchronous signal received through the signal receiver;
a signal processor to process the plurality of individual video signals divided by the signal divider to have a format to be displayable on the display; and
a controller to control the signal processor to process at least one of the plurality of individual video signals output from the signal divider to be displayed on the display according to the individual horizontal synchronous signal and the individual vertical synchronous signal.

19. The display apparatus according to claim 18, wherein the signal processor comprises a PIP processor to perform a PIP function, and
the controller controls the PIP processor and the signal processor to display one of the plurality of individual video signals output from the signal divider as a main picture on the display, and another one of the plurality of individual video signals as a subsidiary picture on a portion of the display.

20. The display apparatus according to claim 18, wherein the composed video signal, the composed horizontal synchronous signal and the composed vertical synchronous signal are composed from a plurality of individual video signals by:
creating a composed horizontal synchronous signal and a composed vertical synchronous signal to synchronize the plurality of individual video signals; and
creating a composed video signal by synchronizing line data of the plurality of individual video signals with the composed horizontal synchronous signal and the composed vertical synchronous signal by a frame unit in a predetermined order.

21. The display apparatus according to claim 20, wherein the composed vertical synchronous signal is created by:
detecting a frequency of an individual vertical synchronous signal of each of the plurality of individual video signals;
calculating a frequency of the composed vertical synchronous signal according to the detected frequency of the individual vertical synchronous signal of each of the plurality of individual video signals; and
creating the composed vertical synchronous signal having the calculated frequency.

22. The display apparatus according to claim 20, wherein the composed video signal is created by:
alternately synchronizing the line data of the plurality of individual video signals with the composed horizontal synchronous signal; and
composing each frame of the plurality of individual video signals and synchronizing the composed video signal with the composed vertical synchronous signal.

23. A method of displaying a picture on a display of a display apparatus, the method comprising:
receiving a composed video signal, a composed horizontal synchronous signal and a composed vertical synchronous signal;
dividing the composed video signal into a plurality of individual video signals according to the composed horizontal synchronous signal and the composed vertical synchronous signal;
generating an individual horizontal synchronous signal and an individual vertical synchronous signal to synchronize each of the plurality of individual video signals according to the composed horizontal synchronous signal and the composed vertical synchronous signal; and
displaying at least one of the plurality of individual video signals on the display according to the individual horizontal synchronous signal and the individual vertical synchronous signal.

24. The method according to claim 23, wherein the displaying of the at least one of the plurality of individual video signals on the display comprises:
displaying one of the plurality of individual video signals as a main picture on the display; and
displaying another one of the plurality of individual video signals as a subsidiary picture on a portion of the display.

25. The method according to claim 23, wherein the composed video signal, the composed horizontal synchronous signal and the composed vertical synchronous signal are composed from a plurality of individual video signals by:
creating a composed horizontal synchronous signal and a composed vertical synchronous signal to synchronize the plurality of individual video signals; and
creating a composed video signal by synchronizing line data of the plurality of individual video signals with the composed horizontal synchronous signal and the composed vertical synchronous signal by a frame unit in a predetermined order.

26. The method according to claim 25, wherein the composed vertical synchronous signal is created by:
detecting a frequency of an individual vertical synchronous signal of each of the plurality of individual video signals;
calculating a frequency of the composed vertical synchronous signal according to the detected frequency of the individual vertical synchronous signal of each of the plurality of individual video signals; and
creating the composed vertical synchronous signal having the calculated frequency.

27. The method according to claim 25, wherein the composed video signal is created by:
alternately synchronizing the line data of the plurality of individual video signals with the composed horizontal synchronous signal; and
composing each frame of the plurality of individual video signals and synchronizing the composed video signal with the composed vertical synchronous signal.
